(19) United States
(12) Patent Application Publication
(10) Pub. No.: US 2016/0255890 A1
(43) Pub. Date: Sep. 8, 2016

(54) MULTI-LAYER WATERPROOF SEAM

(71) Applicant: Tanakorn WANGBUNYEN, Bangkok (TH)

(72) Inventor: Tanakorn Wangbunyen, Bangkok (TH)

(21) Appl. No.: 15/029,192

(22) PCT Filed: Oct. 17, 2013
(86) PCT No.: PCT/TH2013/000056

§ 371 Date: Apr. 13, 2016

(51) Int. Cl. A41D 27/24; B32B 5/02; B32B 7/12; B32B 3/26

(52) U.S. Cl. CPC A41D 27/245; B32B 3/26; B32B 5/02; B32B 7/12; B32B 2307/7265; B32B 2437/00

(57) ABSTRACT

The present invention disclose a multi-layer waterproof seam (100) comprising a first component (10), and a second component (20); the first component (10) comprising a layer of outer shell fabric (15); and the second component comprising at least one layer of adhesive (25) disposed onto a layer of water barrier membrane (30); the said layer adhesive (25) permits fusion or bonding between the first component (10) and the second component (20).

### BACKGROUND OF THE INVENTION

The present invention relates to a multi-layers seam, more specifically, a waterproof multi-layers seam for used in waterproof articles including as an example clothing apparels, bags, shoes and tents.

In the manufacturing of waterproofed articles, the construction of the seam plays a vital role in maintaining waterproofing abilities of the article as one of the most common problems associate with waterproofed article such as clothing apparels, bags, shoes or tents, the water can penetrate thorough the seam reducing the effectiveness in intended waterproofing capabilities of the article.

WO 2011/091351 disclosed a waterproof seam relying on the application of a seam tape that provides a hydrophobic polymer membrane within the seam and long the length of the seam. However, the construction of the seam is rather complicated. Further, the disclosed waterproof seam started with laminated fabric which required subsequent stitching. Accordingly, the proposed seam required the used of seam tape in order to seal the needle hole occurs during stitching. The use of seam tape adds additional cost and/or labor hours. Thus there is a need for alternative waterproof seam.

### SUMMARY OF THE INVENTION

The present invention disclosed a multi-layer waterproof seam comprising at least a first component, a second component wherein at least one adhesive layer is disposed between the first component and the second component. Said adhesive layer is disposed and fused onto the second component enabling bonding between the first component and the second component to form a single garment with waterproof seam. The first component is an outer shell fabric which is cut into panels as per the pattern of the garment. The said panels are joined together by way of stitching or other means including ultrasonic welding. The second component being an inner garment comprising at least a layer of adhesive, or a web adhesive and a layer of water barrier membrane wherein the a layer of adhesive or a layer of adhesive is fused onto a membrane, as a non-insulated second component. The second component can further comprise an insulation package, as an insulated second component. The adhesive later or web adhesive permits bonding between the components while the membrane act as water barrier attaining waterproof characteristics of the seam. It is a key feature of the present invention that the stitching of the first component, i.e. stitching of the outer shell fabric occurs prior coating or laminating, hence avoiding the need to seal the needle hole with seam tape.

In one embodiment of the invention, the invention disclosed a waterproof seam comprising a layer of outer shell fabric as a first component and a web adhesive layer fused with a membrane as a second component. The first component and the second component are fused together using thermo-base fusion process to melt the adhesive to promote bonding to form a single garment with waterproof seam.

In one embodiment, the invention disclosed a waterproof seam comprising a layer of outer shell fabric as a first component and a web adhesive layer fused with a water barrier membrane as a second component, wherein the second component of which comprising a layer of adhesive fused on to a layer of water barrier membrane is prefabricated. The first component and the second component are fused together using thermo-base fusion process to melt the adhesive to promote bonding to form a single garment with waterproof seam.

In one embodiment of the invention, the invention disclosed a waterproof seam comprising a layer of outer shell fabric as a first component, an adhesive layer fused onto a layer laminated membrane with adhesive as a second component, and a layer of fleece. The said fleece layer is fused onto the said laminated membrane. The first component and the second component are fused together using thermo-base fusion process to melt the adhesive to promote bonding to form a single garment with waterproof seam.

In one embodiment of the invention, the invention disclosed a waterproof seam comprising a layer of outer shell fabric as a first component, an adhesive layer fused onto a layer laminated membrane with adhesive as a second component, and a layer of lining fabric. The said layer of lining fabric is fused to the said laminated membrane. The first component and the second component are fused together using thermo-base fusion process to melt the adhesive to promote bonding to form a single garment with waterproof seam.

In one embodiment of the invention, the invention disclosed a waterproof seam comprising a layer of outer shell fabric as a first component and a layer of web adhesive, a layer of laminated membrane with adhesive and a layer of insulation package as a second component. The insulation package comprising continuous or non-continuous filament insulation laminated to a lining fabric.

### BRIEF DESCRIPTION OF DRAWINGS

Advantages and characteristics of the invention will be appreciated from the following description, in which, as a non-limiting example, some preferable embodiments of the principle of the invention are described, with reference to the accompanying drawings, in which:

FIG. 1 illustrates an embodiment of a multi-layers waterproof seam according to the present invention;

FIG. 2 illustrates an embodiment of a multi-layers waterproof seam according to the present invention;

FIG. 3 illustrates an embodiment of a multi-layers waterproof seam according to the present invention;

FIG. 4 illustrates an embodiment of a multi-layers waterproof seam according to the present invention;

FIG. 5 illustrates a construction scheme of the multi-layer waterproof seam of FIG. 1;

FIG. 6 illustrates an alternative construction scheme of the multi-layer waterproof seam of FIG. 1;

FIG. 7 illustrates a construction scheme of the multi-layer waterproof seam of FIG. 2;

FIG. 8 illustrates a construction scheme of the multi-layer waterproof seam of FIG. 3; and

FIG. 9 illustrates a construction scheme of the multi-layer waterproof seam of FIG. 4.

### DETAIL DESCRIPTION OF EMBODIMENTS OF THE INVENTION

The present invention disclosed a multi-layer waterproof seam comprising at least a first component, a second component wherein at least one adhesive layer is disposed between the first component and the second component. Said adhesive layer is disposed and fused onto the second component enabling bonding between the first component and the second component to form a single garment with waterproof seam. The first component comprises a layer of outer shell fabric which is cut into panels as per the pattern of the garment. The said panels of outer shell fabric are then joined together by way of stitching or other means including ultrasonic welding, thermo-base bonding or glue bonding. The second component being an inner garment comprising at least a layer of adhesive or a web adhesive fused onto a layer of membrane or a layer of laminated membrane with adhesive, as a non-insulated second component. The second component can further comprise a layer of lining fabric. The lining fabric may be any types of fabrics including open mesh fabric or fleece fabric. Further, the second component can further comprises a layer of fleece or a layer of an insulation package, as an insulated second component. The adhesive layer or web adhesive permits bonding between the components while the membrane act as water barrier attaining waterproof characteristics of the seam.

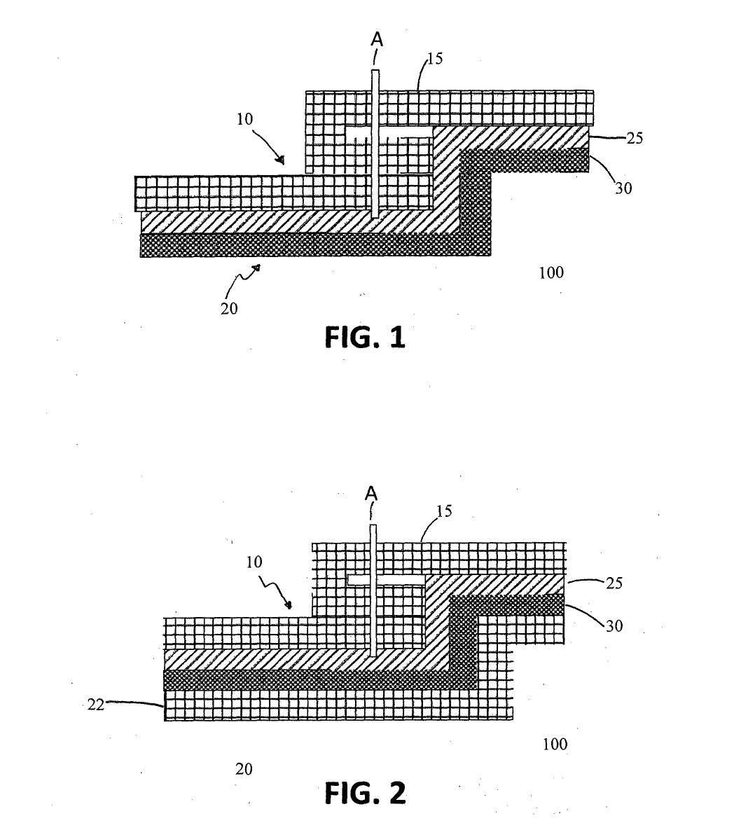

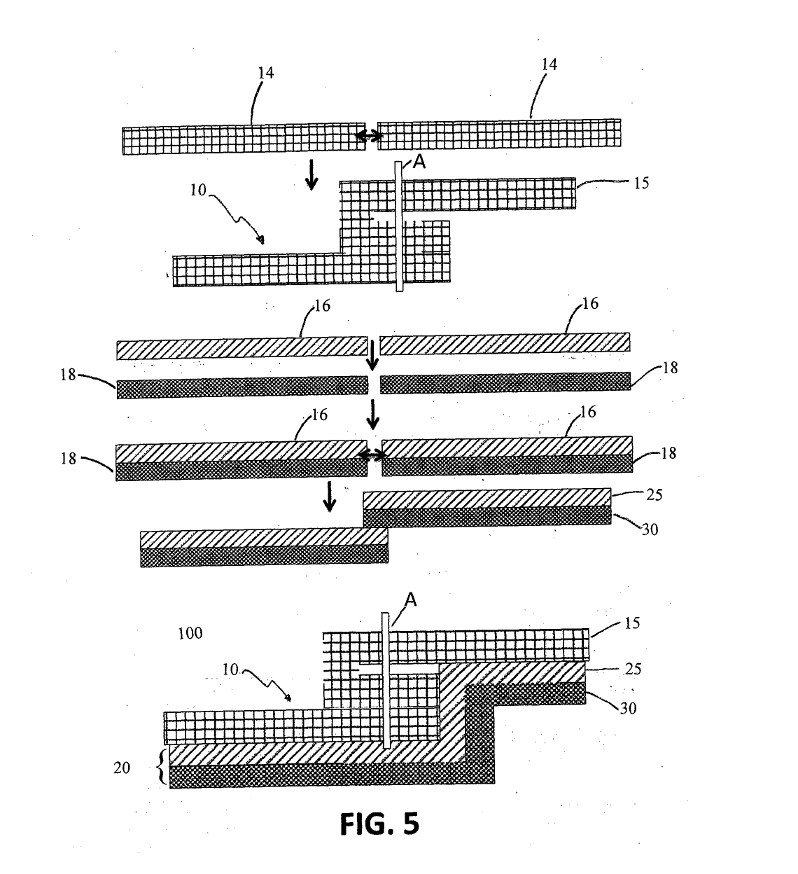

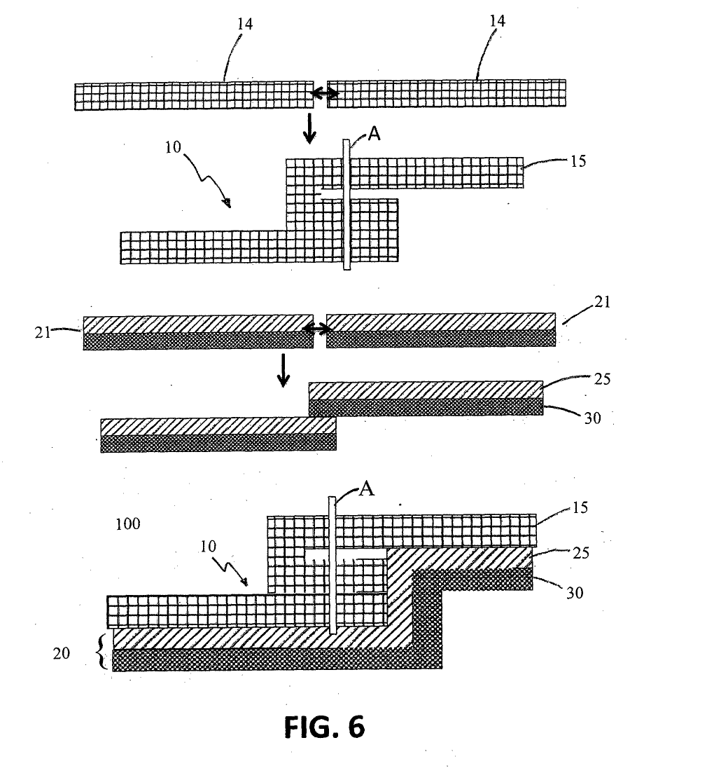

In one embodiment of the invention, as shown in FIG. 1, the invention disclosed an embodiment of a multi-layers waterproof seam 100 comprising a layer of outer shell fabric 15, as a first component 10 and a web adhesive layer 25, fused with a layer of water barrier membrane 30 as a second component 20. The first component 10 and the second component 20 are fused together using thermo-base fusion process to melt the adhesive to promote bonding between the first component 10 and the second component 20 to form a single piece of fabric/garment with a waterproof seam. As an exemplary example, the multi-layers waterproof seam 100 according to this embodiment may be constructed using a construction scheme as illustrated in FIG. 5. In this embodiment, and in this scheme of construction, a layer of outer shell fabric 15 a layer of adhesive 25 and a water barrier membrane layer 30 are provided. These layers of outer shell fabric 15, the layer of adhesive 25, and the layer of water barrier membrane 30 are prepared from panels of outer shell fabric 14, web adhesive 16 and water barrier membrane 18 as per the pattern of the garment or other articles to be made. The separate panels of the outer shell fabric 15 are then held together to form a single sheet of fabric or the layer of outer shell fabric 15. The said panels of the outer shell fabric 14 may be held together by way of stitching, stitch A or other means including ultrasonic welding, or thermo-base bonding or glue bonding forming a prefabricated first component 10. In an alternative construction scheme as shown in FIG. 6, the layer of adhesive 25 of which may be a web adhesive, and the layer of water barrier membrane 30 may also be prefabricated by fusing to one another to form membrane web adhesive assembly 21. The prefabricated membrane web adhesive assemblies 21 are then fused to overlapping one another to form a second component 20 as a single sheet of fabric. The first component 10, i.e. the layer of outer shell fabric 15, made from joined panels of outer shell fabric 14, and the second component 20, i.e. a fused and overlapping membrane web adhesive (i.e. a layer of web adhesive 25 fused to a layer of water barrier membrane 30), are then fused together to form the multi-layer waterproof seam 100. The first component 10 and the second component 20 are fused together by way of appropriate means including thermo-base fusion process to melt the adhesive or to cause the adhesive to adheres to and bonded the two components along the length of the seam. The outer shell fabric faces outward to the wearer and the membrane layer face toward the wearer. The hydrostatic or hydrophobic properties of the water barrier membrane will block the water from penetrating through the seam.

In another possible construction scheme, the adhesive layer 25 may also be a layer of powder adhesive deposited on to the layer of water barrier membrane layer 30 or panels of water barrier membrane 18.

In other words, the multi-layers waterproof seam 100 according to the principle of the present invention comprising the first component 10, and the second component 20 wherein the first component 10 and the second component 20 are fused or bonded to one another by at least a layer of adhesive 25 disposed between the said first component 10 and the said second component 20. The second component 20, in one embodiment, comprising at least a layer of water barrier membrane 30 immediately disposed on or fused onto or bonded to the layer of adhesive 25. The said layer of adhesive 25 may be in a form of a layer power adhesive or a layer of web adhesive. In some other embodiments, the said layer of adhesive 25 may form part of the second component 20 which may be pre-fabricated with additional layers of materials use in constructing the seam or garments or articles which will be further described below.

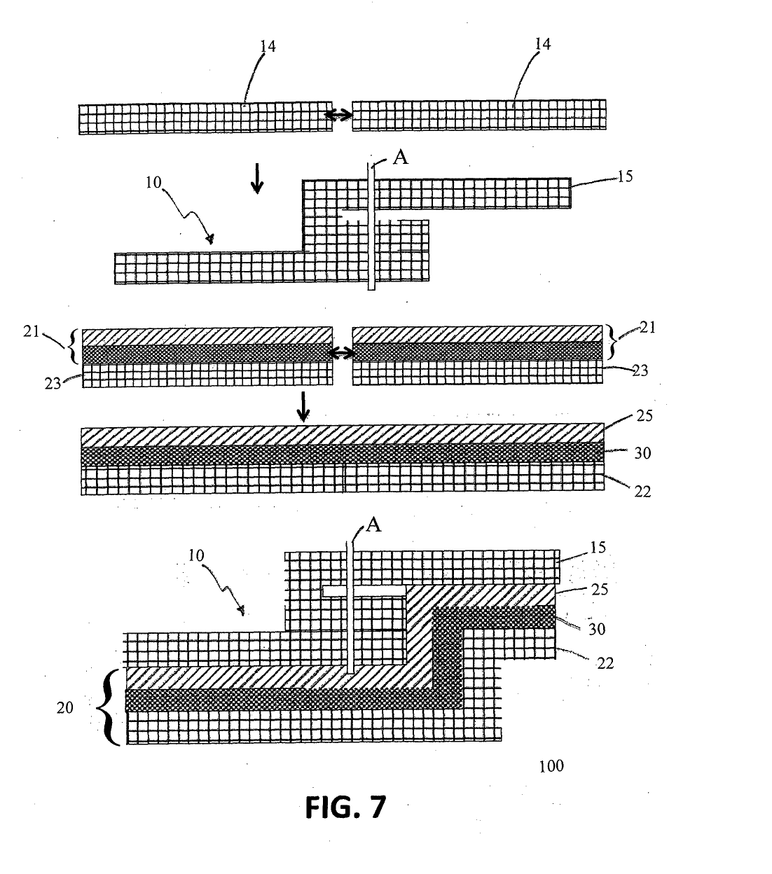

FIG. 2 shows another embodiment of a waterproof seam 100 according to the invention. In this embodiment, the multi-layers waterproof seam 100 comprising a layer of outer shell fabric 15 and a layer of web adhesive 25 and a layer of water barrier membrane 30 as in the earlier described embodiment. However, in the embodiment the multi-layers waterproof seam 100, further comprising a layer of lining fabric 22 fused to the said water barrier membrane 30. An exemplary construction scheme of this embodiment is illustrated in FIG. 7 wherein a layer of outer shell fabric 15 a layer of web adhesive 25 and a membrane layer 30 are provided. The outer shell fabric 14, the web adhesive 16, and the membrane 18 are cut into panels as per the pattern of the garment or other articles to be made. The separate panels of the outer shell fabric 14 are then held together to form a single sheet of fabric or the layer of outer shell fabric 15. The said panels of the outer shell fabric 14 may be held together by way of stitching, stitch A or other means as described in earlier embodiment of the invention forming a prefabricated first component 10. In this construction scheme, the web adhesive 25 and the membrane 30 have already been prefabricated, i.e. the layer of web adhesive 25 and the layer of water barrier membrane 30 have already been fused together to form a membrane web adhesive assembly 21. The prefabricated membrane web adhesive assembly 21 may be available from commercial source, which will also help to cut seam construction time. As the prefabrication of the second component 20, i.e. the water barrier membrane 30 fused with a layer of adhesive 25 to form membrane web adhesive assembly 21 is completed each membrane web adhesive assembly 21 is then welded to overlapping with each other to form a single sheet of fabric. Separate panels of lining fabric 23, which may be a fabric, including open mesh fabric or fleece fabric are then fused to the layer of water barrier membrane 30 of the membrane web adhesive assembly 21 to form a further sub-assembly. Each separate assembly may also be prepared from panels of web adhesive 16, water barrier membrane 18 and line fabric 23 overlaying in respective order. Separate sub-assemblies are then joined together to form a single sheet of which now comprising a layer of adhesive (25) a layer of water barrier membrane and a layer of lining fabric 22 fused in respective order, completing the construction of the second component 20. The first component 10 and the second component 20 are then fused together by way of appropriate means to melt the adhesive or to cause the adhesive to adhere to and bonded the two components along the length of the seam to create a two layers waterproof seam 100. The first component 10, i.e. the joined or stitched, bonded or glued outer shell fabric 15 faces outward to the wearer and the membrane 30 faces toward the wearer. The hydrostatic or hydrophobic properties of the water barrier membrane 30 on the second component 20 will block the water from penetrates through the seam.

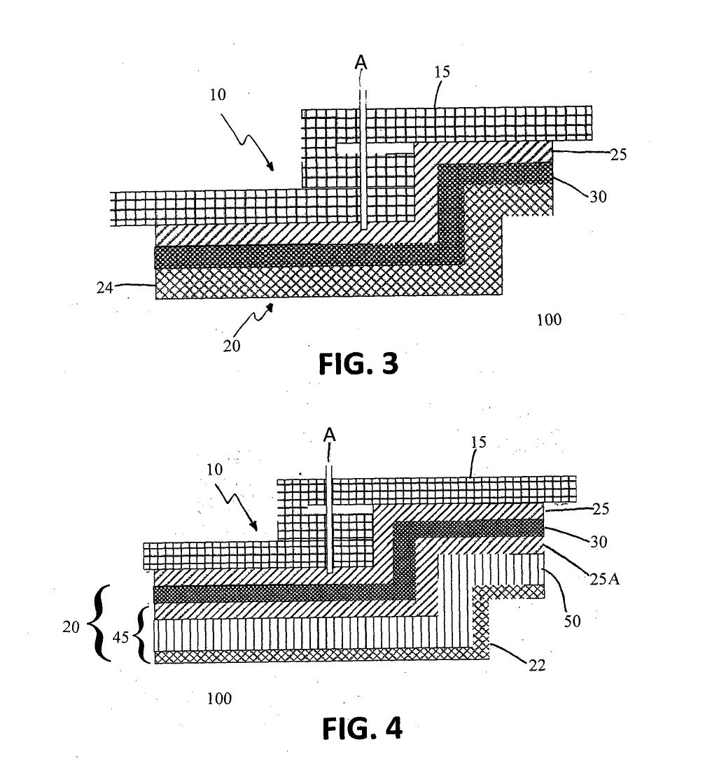

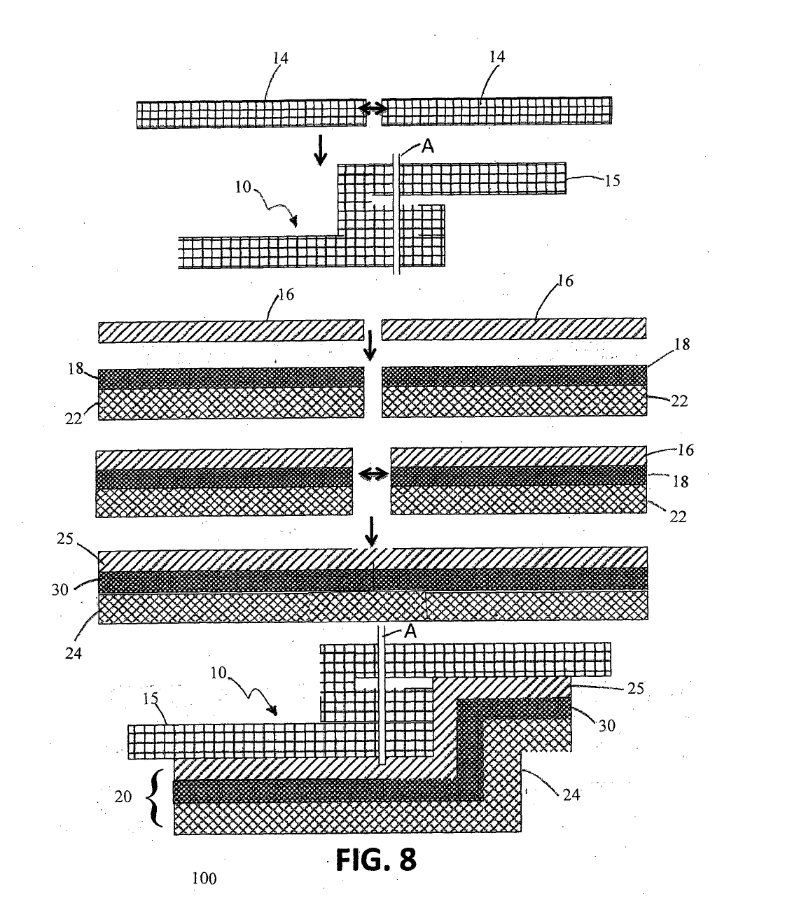

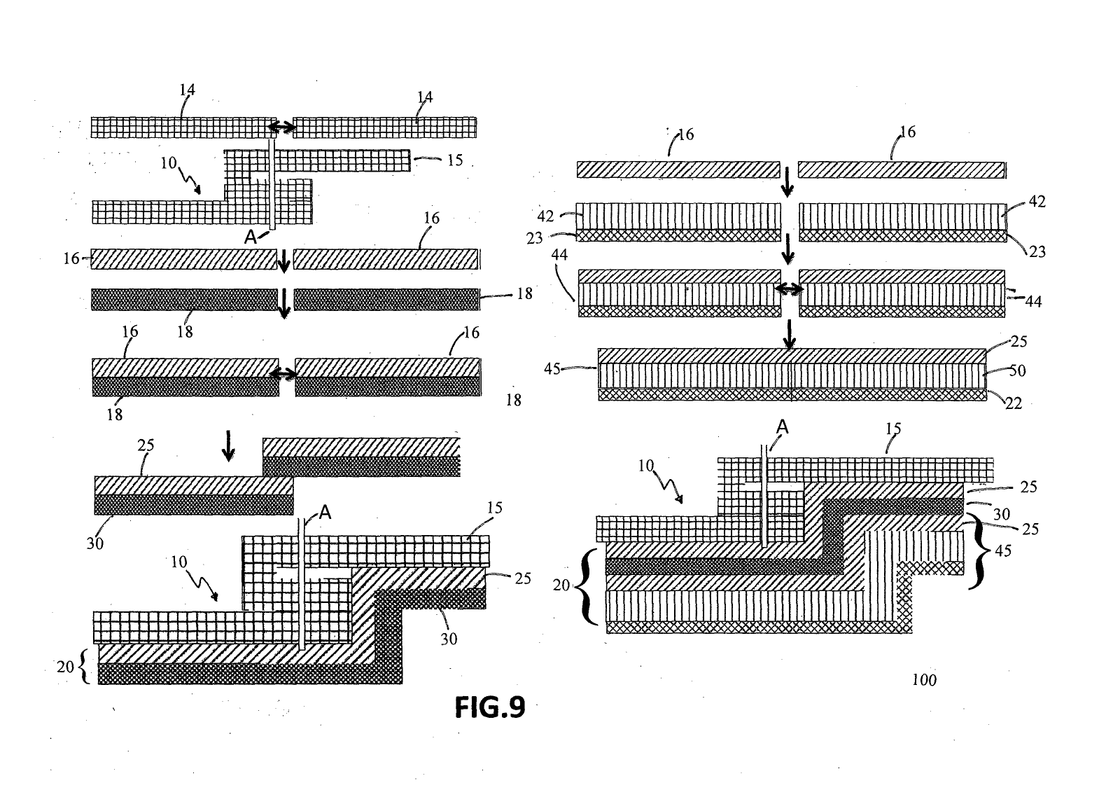

FIG. 3 shows another embodiment of the multi-layers waterproof seam 100 according to the present invention. In this embodiment, the multi-layer waterproof seam 100 comprising a second component 20 of which further comprising a layer of fleece 24. In more detail, in this embodiment, the multi-layers waterproof seams 100 comprises a layer of outer shell fabric 15 to form into the first component 10, a layer of adhesive layer 25 fused onto a layer of water barrier membrane 30 (which can also be a laminated membrane), and a layer of fleece 24 as the second component 20. An exemplary example scheme of construction of the multi-layer waterproof seam 100 according to this embodiment is shown in FIG. 8. In this embodiment, a layer of outer shell fabric, 15, a layer of adhesive 25, a layer of water barrier membrane 30 (or a layer of water barrier membrane with adhesive 21), and a layer of fleece 24 are provided. The first component 10 comprises separate panels of outer shell fabric 14 which have been cut as per the pattern of the garment or articles to be produced are held together by stitching (stitch A) or other means including ultrasonic welding, thermo-base bonding or glue bonding as described in the earlier embodiments. The second component 20 comprises separate panels of web adhesive 16 water barrier membrane 18, or prefabricated web adhesive membrane assembly 21 of which comprising a layer of adhesive 25, a water barrier membrane 30. The second component 20 in this embodiment further comprising a layer of fleece 24 assembled onto the web adhesive membrane assembly 21 of which previously described. The assembly between the layer water barrier membrane 30 with the layer of fleece 24 may be prefabricated and a layer of adhesive or web adhesive 25 may subsequently be assembled thereon. Alternatively, the layer of adhesive 25 and the layer of water barrier membrane 30 may be prefabricated and a layer of fleece 24 is subsequently assembled thereon. Separate panels of the prefabricated assembly are then joined together to form a single sheet of fabric and a completed second component 20. Again, prefabrication of adhesive layer 25 with membrane layer or laminated membrane adhesive 30, or a layer of membrane or laminated membrane 30 with a layer of fleece 24 may be a ready-made fabricated fabric available from commercial source. The first component 20 and the second component 20 are then fused together to form a completed multi-layer waterproof seam 100. The first component 10 and the second component 20 are fused together by way of appropriate means including thermo-base fusion to melt the adhesive or to cause the adhesive to adheres to and bonded the two components along the length of the seam to create the seam according to the embodiment.

FIG. 4 shows another embodiment of multi-layers waterproof seam 100 according to the present invention. In this embodiment of the invention, the multi-layer waterproof seam 100 is an insulated multi-layers waterproof seam. That is, in this embodiment, the second component 20 further comprising an insulation package 45. In other words, the multi-layers waterproof seam 100 as illustrated in FIG. 1 now becomes a sub-assembly for the construction of the embodiment of the waterproof seam 100 according to this embodiment and hence its construction will not be repeated. The said insulation package 45 comprising a layer of adhesive 25, which may be a web adhesive, fused onto a layer of continuous or non-continuous filament insulation 50, and a layer of lining fabric 22 laminated to the said layer of continuous or non-continuous filament insulation 50. In more detail, in this embodiment, the multi-layers waterproof seam 100 comprising a layer of outer shell fabric 15, a layer of adhesive or web adhesive 25, a layer of water barrier membrane 30, a second layer of adhesive 25A, a layer of insulation filament 50 and a layer of lining fabric 22 assembled in sequential order. That is, a layer of adhesive or web adhesive 25 is disposed between the layer of the outer shell fabric 15 and a layer of water barrier membrane 30, and an insulation package 45 with another layer of adhesive or web adhesive 25A disposed between the layer of the membrane 30 and the insulation filament 50 fused with the layer of lining fabric 22. Prefabrication of any components and at any steps of construction to produce a sub-assembly of the non-insulated multi-layer waterproof seam of FIG. 1, of which form a component of the multi-layers waterproof seam 100 according to this embodiment may also be made by the techniques and method as previously described. Further, the insulation package 45 may also be prefabricated. The said insulation package 45 may be prefabricated as a sub-assembly comprising a layer of web adhesive 25 (prepared from separate panels of web adhesive 16) fused onto a layer of continuous or non-continuous filament insulation 50 (prepare from separate panels of continuous or non-continuous filament insulation 42) laminated to a layer lining fabric 22 (prepared from separate panels of lining fabric 23). Simply put, in accordance with the construction scheme of the multi-layer waterproof seam 100 according to this embodiment, first prepare a seam according to FIG. 1 and set aside, as a sub-assembly. Next, a separate panel of the web adhesive 16 is fused to a corresponding panel of insulation package 44 forming into preassembled web adhesive insulation package 45 of which comprising a layer of web adhesive 25 fused onto a layer of continuous or non-continuous filament insulation 50 laminated to a layer of lining fabric 22. The separate panels of insulation package 44 are then together to form a single sheet by way of ultrasonic welding or stitching or other means. The said insulation package 45 is then fused to the second component 20 of the already assembled subassembly, i.e. the seam as shown in FIGS. 1 and 5. The adhesive layer 25 on the insulation package allows the insulation package 45 to fuse with the said preassembled subassembly forming into insulated multi-layers waterproof seam 100 according to the embodiment.

The term “multi-layers” mentioned throughout the foregoing description in some instances are referring characteristic of the seam according to the principle of the present invention which may of different layers of shell fabric, adhesive, membrane, web adhesive membrane, lining fabric, fleece or insulation package or sub-assembly constructed according to the various embodiments of the invention. In some other instance, the term is referring to different component, including the first component, the second component and insulation package according to the various embodiments of the invention.

From the foregoing description, it is clear that the principle of the present invention involves using outer shell fabric which is neither coated nor laminated with water barrier membrane to form an outer shell. Any coating or laminating occurs only after stitching or bonding or joining of the outer shell fabric is completed, hence avoiding using seam tape to seal the needle holes. The seam is made waterproof by way of adhering of the water barrier membrane to the outer shell using a layer of adhesive after completion of stitching of the outer shell, then lining or insulation fabric or insulation package is added to the outer shell. Further, the invention utilizes at least a layer of adhesive, or web adhesive which is to be fused (as shown in FIG. 1) or has been pre-fused (as shown in FIG. 2) with water barrier membrane or laminated membrane and wherein the said adhesive layer is disposed between the first component and the second component. Said adhesive layer is disposed and fused onto the second component enabling bonding between the first component and the second component to form a single garment with waterproof seam. The layer of laminated web adhesive or web adhesive membrane stop water from penetrating through the needles holes on the outer shell without the use of seam tape as laminating or coating occurs post stitching. Further, it is intended that the first component described herein is referring to an outer shell fabric which has been cut into panels according to the pattern of the garment. The said outer shell fabric is faced outward to the wearer and may also be pre-treated to acquire certain properties to meet the intended use of such fabric by the garments manufactures or suppliers. For example, it is may be pretreated with a water repellant agent to enhance water proofing abilities of the fabric or other coating agents for other purposes. Further, it is intended that the second component described herewith is referring to an inner garment which face toward the wearer. The second component may be insulated or non-insulated types. In the non-insulated type, the second component may be simply a layer of adhesive fuses onto a membrane or a web adhesive membrane. It can also be a web adhesive membrane with a layer of lining fabric. In the insulated type, the second component can be a layer of adhesive fused with fleece or a layer of adhesive with a laminated membrane with fleece or with an insulation package. It will be apparent by the principle of the present invention that the component of the multi-lay seam according to the present invention, especially, the second component may be prefabricated on the production site or from the fabric manufactures and hence the steps of construction of the seams may be approached differently.

According to the principle of the present invention sewing or stitching only occurs during joining of the panels of the outer shell fabric. No stitching is made in the second component or during assembly of the first component to the second component or during prefabrication of the second component. Accordingly, the utilization of adhesive layer and water barrier membrane according to the present invention provide waterproof seams effectively and efficiently without using seam tape as in the cited prior art. Without using of seam tape and the possibility of prefabricating the certain assembly of the second component by the fabric manufacturers offer advantages in term of lower set up times, break-down times, reduce lead time of outsourcing of sub-assembly and overall associated costs.

It will be apparent by a person skilled in the art that various modifications to the components and its constructions sequence and method may be made.

1. A multi-layers waterproof material having waterproof seam comprising:
a first component comprising a layer of shell fabric and a second component comprising at least a layer of water barrier membrane;
wherein the first component and the second component are fused or bonded to one another by a layer of adhesive disposed between the said first component and the said second component;
wherein the first component comprises panels joined together forming said layer of shell fabric and includes stitches formed during joining said panels prior to fusing or bonding of the first and second components, said stitches not extending into the water barrier membrane of the second component.

2. The multi-layers waterproof material according to claim 1, wherein the said layer of adhesive forms part of the second component before the fusing or bonding of the first and second components is performed.

3. The multi-layers waterproof material according to claim 2, wherein the first component comprises panels of outer shell fabric which each are cut according to a pattern of an item to be produced, and subsequently joined together by way of stitching or ultrasonic welding or thermo-base bonding or glue-bonding.

4. The multi-layers waterproof material according to claim 2, wherein the second component comprises panels of web adhesive fused onto panels of water barrier membrane and joined to overlap one another forming into a single sheet defining the layer of adhesive and the layer of water barrier membrane.

5. The multi-layers waterproof material according to claim 2, wherein the said layer of adhesive is a layer of adhesive powder or a web adhesive.

6. The multi-layers waterproof material according to claim 3, wherein the second component is a prefabricated membrane web adhesive assembly formed from panels of web adhesive fused onto panels of water barrier membrane and the said membrane adhesive assembly is joined to overlap one another forming into a single sheet.

7. The multi-layers waterproof material according to claim 1, wherein the second component further comprises a layer of lining fabric selected from fabric, open mesh fabric fused to the layer of water barrier membrane of the second component.

8. The multi-layers waterproof material according to claim 1, wherein the second component further comprises a layer of fleece fused to the layer of water barrier membrane of the second component.

9. The multi-layers waterproof material according to claim 1, wherein the second component further comprises an insulation package; said insulation package comprising a layer of adhesive fused onto a layer of continuous or non-continuous insulation filament laminated to a layer of lining fabric.

10. The multi-layers waterproof material according to claim 1, wherein the first component is constructed from panels of outer shell fabric which has not been pre-coated or pre-laminated.

11. The multi-layers water proof material according to claim 1, wherein the second component is pre-fabricated.

12. The multi-layers water proof material according to claim 9, wherein the insulation package-is pre-fabricated.
